(19) United States
(12) Patent Application Publication
(10) Pub. No.: US 2012/0008919 A1
(43) Pub. Date: Jan. 12, 2012

(54) DATA RECORDING METHOD, DATA RECORDER, AND DATA RECORDING MEDIUM

(75) Inventor: Akinobu Watanabe, Kawasaki (JP)

(73) Assignee: Hitachi Consumer Electronics Co., Ltd.

(21) Appl. No.: 13/093,000

(22) Filed: Apr. 25, 2011

(30) Foreign Application Priority Data
Jul. 12, 2010 (JP) 2010-157420

(51) Int. Cl. H04N 9/80

(52) U.S. Cl. 386/248; 386/E05.001

(57) ABSTRACT

Multiple contents are downloaded and additionally recorded oo.nto one recording medium while maintaining play compatibility with existing players. Unused numbers other than file numbers already recorded on a recording medium are notified to a server, and after changing management information to avoid number duplication, additional contents are downloaded.

### INCORPORATION BY REFERENCE

This application relates to and claims priority from Japanese Patent Application No. 2010-157420 filed on Jul. 12, 2010, the entire disclosure of which is incorporated herein by reference.

### BACKGROUND OF THE INVENTION

(1) Field of the Invention

The present invention relates to a data recording method, a data recorder, and a data recording medium and particularly to a data recording method, a data recorder, and a data recording medium for downloading and recording onto a recording medium.

(2) Description of the Related Art

There are services for downloading and recording AV contents onto optical discs such as DVDs (Digital Versatile Discs) and BDs (Blu-ray Discs) from a server on the Internet. For example, by use of DVD recorders and PC software for “DVD Burning” provided by KDDI CORPORATION, contents are protected by the CPRM technology and downloaded and recorded onto recordable DVDs.

On the other hand, the standardization for downloading onto BDs is now being considered. For example, Japanese Patent Application Laid-open No. 2008-159233 discloses the method in which multiple contents can be additionally downloaded and recorded onto recordable BD mediums such as BD-Rs and BD-REs.

Japanese Patent Application Laid-Open No. 2007-179671 discloses the method for recording onto recordable BD mediums such as BD-Rs and BD-REs by the BDMV format used mainly in BD-ROMs, which are read-only mediums.

In the BDMV format, each scene is divided into separate files as units called clips, and five-digit consecutive integers are used as naming convention of filenames of clips (described in White Paper Blu-ray Disc Format 2.B Audio Visual Application Format Specifications for BD-ROM March 2005).

For example, an AV content of a movie including ten scenes may include ten stream files of filenames from 00000.M2TS to 00009.M2TS.

### SUMMARY OF THE INVENTION

Some methods for downloading multiple contents onto one disc can be considered.

For example, one content corresponds to one partition by partitioning, and subfolders are produced to store one content in one subfolder.

However, the contents on the mediums structured as above cannot be played in and have no compatibility with the existing BD players already penetrating the market. There is a demand for reducing a cost of updating firmware of the existing players by maintaining a compatibility with the former BD players if possible. In this case, one volume, one partition, and the same folder structures defined by the existing BD standard may be required.

In the existing BD standard, in each content, one of unique file numbers from 00000 to 99999 is assigned to each clip (which is a combination of an AV stream file and its management information) to specify a clip. Between different contents, there is no rule in how to number files. When originally different contents are managed as one content, duplication of file numbers occurs.

For example, in commercial BD contents of a movie company A, file numbers of clips 00000 to 00050 may be used in a BD (1) and file numbers of clips 00000 to 00040 may be used in a BD (2), and in commercial BD contents of a movie company B, file numbers of clips 00000 to 00080 may be used in a BD (3). In such a case, the file numbers from 00000 to 00040 or from 00000 to 00050 are duplicated.

When the contents are treated in different recording mediums, no problem occurs. When the contents are managed as one content on one recording medium, a problem occurs. In downloading and recording, the same problem occurs.

Especially downloading and recording, which takes time, is suitable for contents having a relative small data amount, such as short movies and cooperation dramas, which may be highly needed to be additionally recorded onto one recording medium.

Therefore, to download and record multiple contents onto one disc while maintaining compatibility with the existing BD players, it may be necessary to avoid duplication of file numbers of clips of different contents.

According to the present invention, the above problem is addressed using a structure described, e.g., in claims.

According to the present invention, multiple contents may be advantageously downloaded and recorded onto one disc while maintaining compatibility with the existing BD players.

Further, recording is advantageously possible even when unused numbers are fragmented in discrete value ranges because as many numbers as needed can be used by collecting the values.

### BRIEF DESCRIPTION OF THE DRAWINGS

These and other features and objects and advantages of the present invention will be come more apparent from the following description when taken in conjunction with the accompanying drawings wherein:

FIG. 1 shows a structural diagram of a server, a recorder, and a disc;

FIG. 2 shows a basic structural diagram of folders and files of the BDMV format;

FIG. 3 shows a flowchart of downloading and recording;

FIG. 4 shows a structural diagram of folders and files after downloading and recording;

FIG. 5 shows a diagram of menus at the time of playing;

FIG. 6 shows a logical data structure before downloading;

FIG. 7 shows a logical data structure No. 1 after downloading;

FIG. 8 shows a logical data structure No. 2 after downloading;

FIG. 9 shows a logical data structure No. 3 after downloading; and

FIG. 10 shows a diagram of management information generation on a server.

### DETAILED DESCRIPTION OF THE EMBODIMENT

Hereafter, embodiments of a data recording method, a recorder, and a recording medium of the present invention are described in detail in reference to the appended figures.

### Embodiment 1

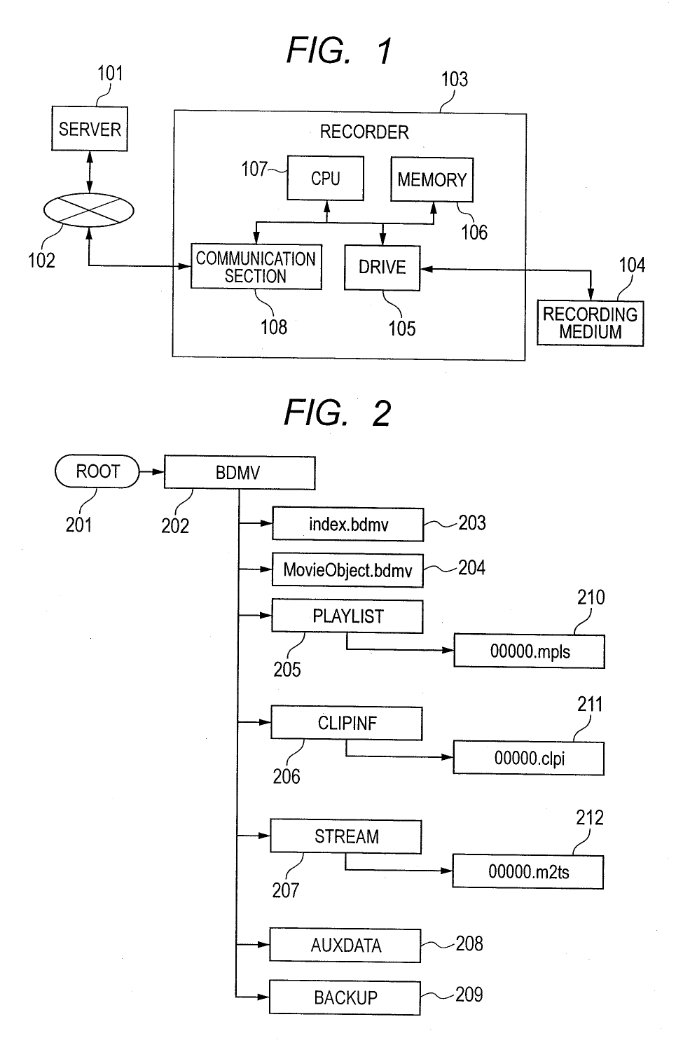

FIG. 1 shows a structure of a first embodiment of the present invention.

A server 101 stores contents to be downloaded. This server is, e.g., a designated content server provided by a movie company. In this case, BDMV contents may be provided.

A network 102 connects the server 101 and a recorder 103. For example, the network is the Internet (World Wide Web).

The recorder 103 downloads and records contents. For example, as the recorder, a BD recorder having a built-in BD drive can be used. In addition, this structure may use, as the recorder, a personal computer having a built-in or external BD drive and SDHC card writer and a KIOSK terminal which is installed in public facilities such as stations and in DVD/BD rental shops and convenience stores and which is designated for an electronic sell-through.

A recording medium 104 records downloaded contents. For example, the medium may use a BD-RE, a rewritable Blu-ray Disc. In addition, the medium may use, e.g., an SDHC card, which uses a semiconductor memory as a recording medium, and an iVDR, which is a HDD (Hard Disc Drive) having metal discs to which a magnetic material is applied and mounting a copyright protection circuit.

A drive 105 records and lays contents on the recording medium 104. For example, the drive may use a BD drive, which enables recording onto BD-REs. In addition, the drive may use an SDHC card writer, an iVDR adapter, etc. based on a recording medium.

A memory 106 temporarily stores contents to be recorded by the drive 105 onto the recording medium 104. For example, the memory may use an SD-RAM. In addition, the memory may use part of an HDD built in the recorder.

A CPU 107 controls the drive 105 to control downloading of contents via a communication section 108 and then to record downloaded contents onto the recording medium 104 via the memory 106. The CPU may build the memory 106 therein. In addition, the CPU may use an SoC (System on Chip), which is an integrated circuit of the other sections.

The communication section 108 accesses the server 101 via the Internet and downloads contents. For example, the communication section 108 may use a network chip, which is an integrated circuit of network communication functions. In addition, the communication section 108 may use an Ethernet (registered trademark) card.

FIG. 2 shows a folder structure and file structure of the recording medium of the first embodiment of the present invention. FIG. 2 shows a BDMV structure, which is one of the BD standards.

A root folder 201 is a top level root folder, and all data are contained under the root folder or subfolders as files.

A BDMV folder 202 contains subfolders and files defined by the BDMV standard.

An index file 203 stores information about all the contents contained in the recording medium.

A movie object file 204 stores information such as a play sequence etc.

A play list folder 205 stores play list files which define a play order of scenes.

A clip information folder 206 stores clip files which store information about AV stream files.

A stream folder 207 stores AV stream files themselves.

An external data folder 208 stores data such as added font data.

A backup folder 209 stores copies of the index file 203, the movie object file 204, the play list folder 205, the clip information folder 206, a play list file 210, and a clip file 211. The copy has the same names as their source files or folders.

The play list file 210 defines a play order of scenes.

The clip information file 211 stores information about an AV stream file.

An AV stream file 212 is a file of stream data encoded by MPEG2-TS.

File extensions of the play list file 210, clip information file 211, and AV stream file 212 are MPLS, CLPI, and M2TS, respectively.

Filenames for the play list file 210 are integers from 00000 to 99999.

Filenames for the clip information file 211 and AV stream file 212 are integers from 00000 to 99999, which are the file numbers.

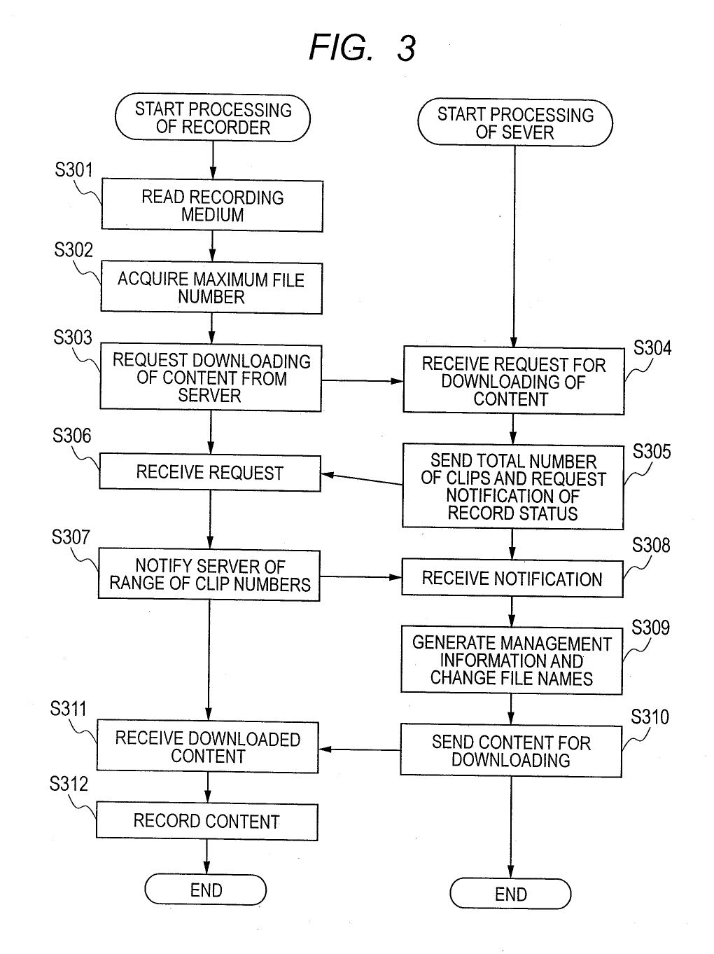

FIG. 3 shows a flowchart of downloading by the recorder 103 and server 101 of the first embodiment of the present invention.

First, when the recording medium 104 is inserted in the recorder 103, the CPU 107 instructs the drive 105 to access the recording medium 104 and responsively the drive 105 reads information recorded on the recording medium 104 (Step S301). The information read at this time includes, e.g., ID information and MKB (Media Key Block) information about the recording medium, an index file, and a movie object.

Next, unused file numbers are acquired by sorting files in the STREAM folder or CLIPINF folder by a filename (Step S302). At this time, the unused file numbers are not always sequential, but may include multiple groups of numbers in discrete ranges.

A request for downloading of a content is sent to the server 101 (Step S303).

The server, which has received the download request (Step S304), notifies the recorder of the total number of clips and total number of play lists of the requested content, and requests the recorder to send a logical recording status of the recording medium including the maximum file numbers used for file names of clip information files and AV stream files and information recorded on management information files such as the play list file, movie object file, and index file (Step S305). The recorder, which has received the request (Step S306), notifies the server of a number group collecting the necessary number of file numbers in increasing value order from the unused file numbers acquired in Step S302 (Step S307).

The server, which has received the unused file numbers and the recording status notification (Step S308), generates management information and changes each filename based on the recording status information such as the received unused file numbers (Step S309). After that, the server starts downloading of the content (Step S310), and the recorder receives the downloaded content (Step S311) and records the content onto the recording medium (Step S312).

In addition to the operation for acquiring unused file numbers by sorting in Step S302, an operation in which a field to record unused file numbers is provided to a management file such as a play list file and an index file and the unused file numbers are read from the field before additional recording is an alternative of Step S302, for example. By adding a step of updating the unused file number field after additional recording, the desired purpose can be attained and advantageously the load of the sorting can be reduced collaterally.

As a trigger to request downloading at this time, a user may select downloading from a menu displayed on a screen of a display monitor connected to the recorder, and a program recorded on the recording medium may be automatically executed during loading to start downloading.

### [Notification of the Maximum Number of Play List]

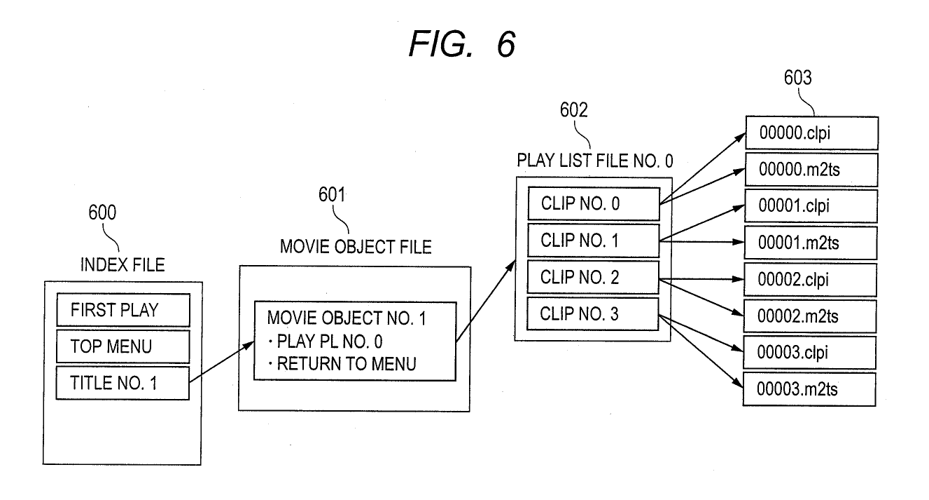

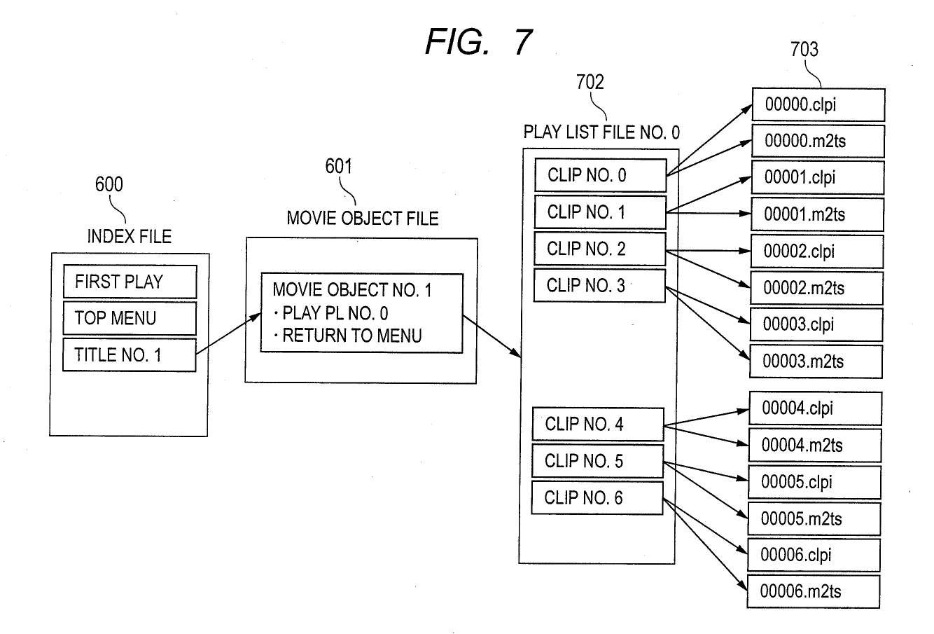

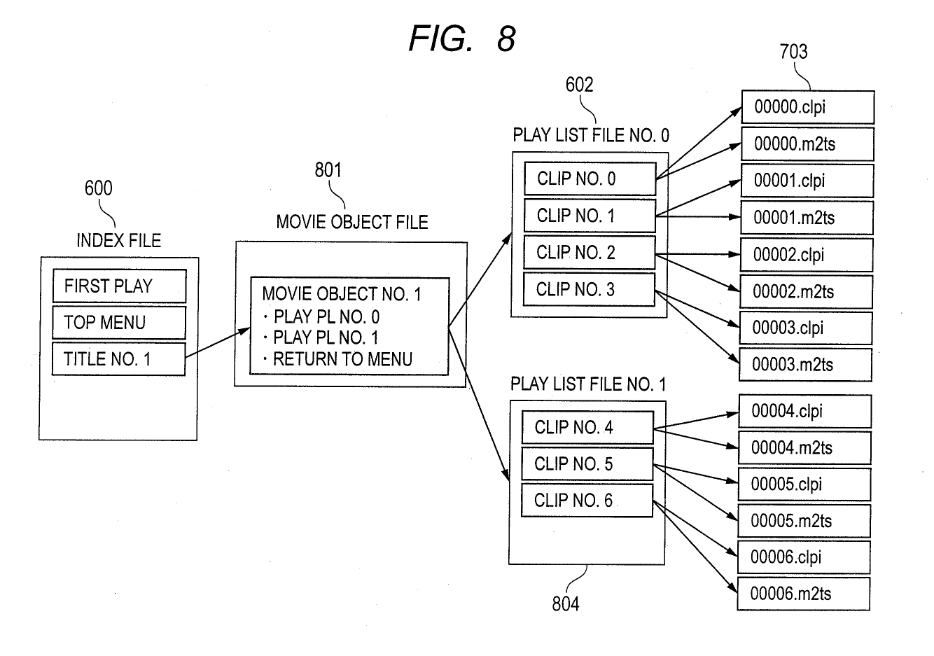

As shown in FIGS. 6 and 8 after mentioned, as a file number notified to the server, the maximum value of file numbers of play list files (MPLS files) may be notified in addition to that of file numbers of clips (file numbers of CLPI files and M2TS files). That is, this notification is made when a new play list file is additionally recorded on the recording medium.

In this case, in addition to unused file numbers of clips, unused file numbers of play lists are notified to the server, avoiding number duplication of play list files as well as of the clip files.

In the example of FIGS. 6 and 8, only one play list file 602, No. 0, is recorded before downloading (FIG. 6). At the same time as or before or after the notification of unused numbers of clip files, a number range of No. 1 to No. 99999 is notified to the server because a range of unused numbers of play list files is No. 1 or over. The server can set a number of a play list file 804 to be downloaded to a head number (No. 1) of the notified range of the unused numbers.

### [Notification of the Maximum Number of Movie Object]

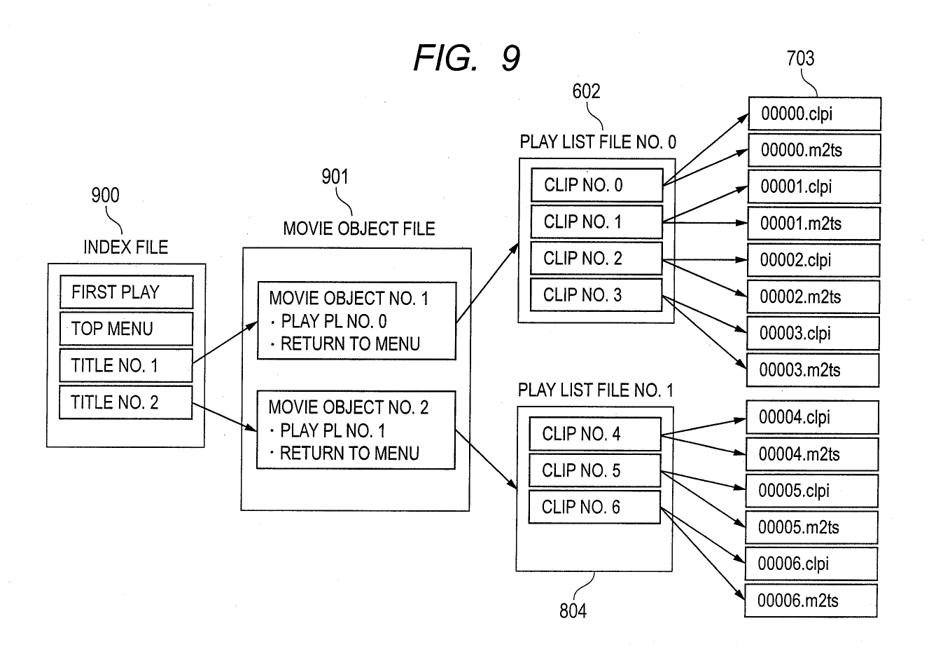

As shown in FIGS. 6 and 9 after mentioned, information about a movie object may be also notified to the server. That is, in this case, a content to be downloaded may be additionally recorded on the recording medium as a title independent of a title already recorded on the recording medium.

In this case, in addition to unused file numbers of clips and unused file numbers of play list files, unused numbers of movie objects and unused numbers of titles are notified to the server, avoiding number duplication of movie object numbers and of title numbers as well as that of the clip files. In the example of FIGS. 6 and 9, before downloading, only a movie object No. 1 is recorded on a movie object file 601, and only a title No. 1 is recorded on an index file 600. Therefore, at the same as or before or after notification of unused numbers of clip file numbers, since a range of unused numbers of movie objects is No. 2 or over and a range of unused numbers of title numbers is No. 4 or over, the movie object number range of No. 2 to No. 99999 and the title number range of No. 4 to No. 99999 are sent to the server. Accordingly, the server can set a number of a movie object added to a movie object file 901 to the minimum number (No. 2) of the sent unused file numbers.

### [Notification of the Maximum Number by Type]

Further, a movie object file may contain not only movie objects but also BD-J objects after mentioned, or may contain only BD-J objects. In such cases, by sending unused numbers of object numbers by each type of the objects separately, an object number of a title to be downloaded can be advantageously specified more correctly.

That is, when a title to be downloaded is a movie object, the minimum value of the notified unused movie object numbers may be set as the object number, and when a title to be downloaded is a BD-J object, the minimum value of the notified unused BD-J object numbers is set as the object number.

### [Transmission of all Management Files]

Since not only unused numbers of file numbers of clips but also multiple pieces of information such as unused file numbers of play list files and the numbers of movie objects and BD-J objects may be required to sent to the server, the following procedure to send the information can be considered.

That is, instead of unused numbers, all the descriptions of management files such as play list files, movie object files, and index files are sent to the server.

Accordingly, a longer transfer time may be required because a data amount to be sent to the server is larger than that in sending only the maximum value, but the recorder can search for a range of unused numbers more easily. Therefore, processing of the recorder can be advantageously reduced and a cost for installation of the processing can be advantageously reduced.

When a data amount to be sent is large, compressed data is sent, advantageously reducing the processing time.

Further, the similar advantage as above can be obtained by deleting management files including only data unrelated to file numbers from the data to be sent.

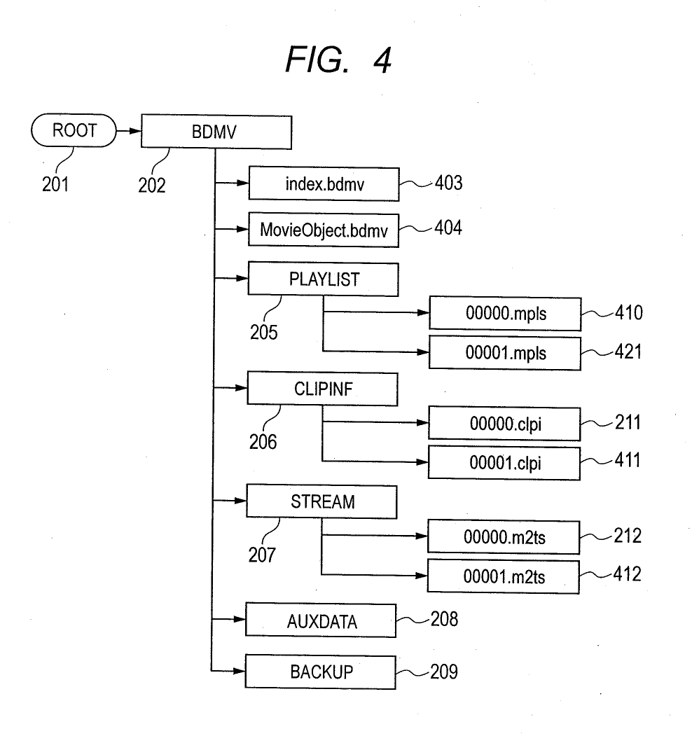

FIG. 4 shows a folder structure and file structure of a recording medium after downloading and recording in the first embodiment of the present invention.

This shows a case in which a downloaded content is additionally recorded on the recording medium having the structure shown in FIG. 2. The same elements as FIG. 2 are not explained.

The changes from FIG. 2 are as follows.

(1) An index file 403 has been updated.
(2) A movie object file 404 has been updated.
(3) A play list file 421 has been added.
(4) The play list file 410 has been updated.
(5) A clip information file 411 has been added.
(6) An AV stream file 412 has been added.
(7) The management Files contained in the backup folder and corresponding to the above (1) to (5) have been updated or added.

There is no change except the above (1) to (7). Therefore, a desired aim can be attained by updating or adding only minimum required files.

Particularly, advantageously, it is not necessary to change clip information files and AV stream files recorded in advance, the change processing and the changed data amount can be reduced and thus a processing time can be reduced.

Since (1) and (2) are unnecessary in the example shown in FIG. 7 after mentioned and since (1) is unnecessary in the example shown in FIG. 8 after mentioned, changes are advantageously further reduced.

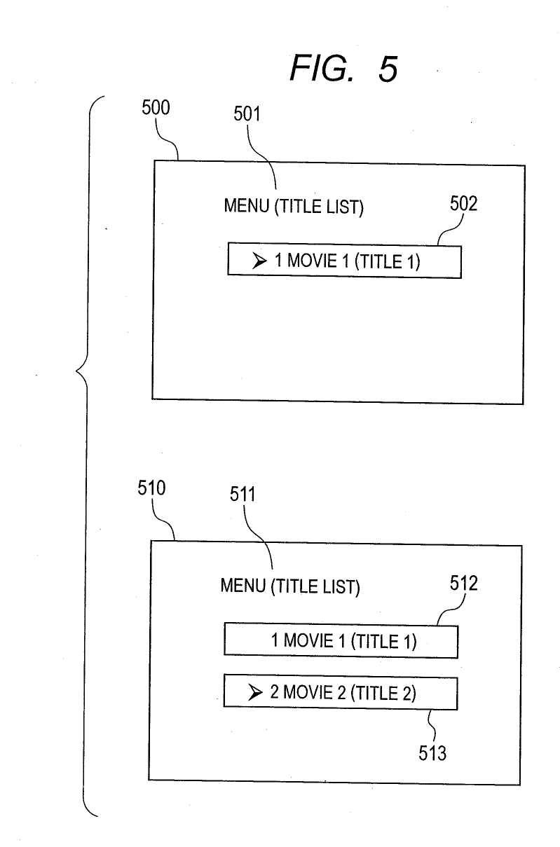

FIG. 5 shows that titles can be selected in a menu as play processing in an existing BD player.

A menu screen 500 is shown before downloading. A movie list 501 shows a list of titles (works) contained in the recording medium, and an icon 502 shows “Movie 1” as the first title.

Only the icon 502 can be selected in the menu screen 500 before downloading. The icon 502 has been selected by a cursor.

A menu screen 510 is shown after downloading. A menu 511 shows a list of titles (works) contained in the recording medium, and an icon 512 shows “movie 1” as the first title. An icon 513 shows “film 2” as the second title.

The icons of two titles, 512 and 513, can be selected in the menu screen 510 after downloading and an icon 513 has been selected by a cursor.

When an icon is selected and determined on the menu screen, a command described in a corresponding movie object is executed to play a play list specified by a play command.

FIG. 6 shows a logical data structure of the recording medium before downloading.

The index file 600 includes information about a first play title, a top menu title, and the other general titles contained in the recording medium. For example, the index file 600 includes information about which movie object corresponds to a title No. 1.

The movie object file 601 includes one or multiple pieces of movie object information. For example, the movie object file 601 includes information about the movie object No. 1 referenced by the title No. 1, and describes commands such as “play a play list No. 0” and “Return to menu after play.”

A play list file No. 0 is shown by 602 and includes one or multiple pieces of clip information forming the play list. For example, the play list No. 0 played by the movie object No. 1 includes four clips from clip No. 0 to clip No. 3.

A file group 603 corresponds to clips, and lists CLPI files and M2TS files having filenames from 00000 to 00003. For example, the clip No. 0 specifies a 00000.CLPI file and a 00000.M2TS file. CLPI files and M2TS files are stored in the CLIPINF folder and STREAM folder, respectively.

As shown above, the recording medium before downloading includes four clips of the file numbers 00000 to 00003 and one play list of the play list number No. 0.

As the play operation, the play list No. 0 is played in response to an instruction to play the title No. 1 based on a command described in the movie object No. 1. That is, the play list No. 0 is played in order of the clip No. 0, clip No. 1, clip No. 2, and clip No. 3, and after that the menu is displayed.

Hereafter, referring to FIGS. 7, 8, and 9, three examples of logical data structures of the recording medium after downloading and recording are shown.

FIG. 7 shows the first example of the logical data structure of the recording medium after downloading and recording.

The same elements as FIG. 6 are not explained.

The play list file No. 0, shown by 702, is changed from the play list file 602 in that clips Nos. 4 to 6 are added after the clip No. 3. Therefore, when the play list No. 0 is played by the command described in the movie object No. 1, seven clips from the clip No. 0 to clip No. 6 are played sequentially.

A file group 703 corresponds to clips, and includes CLPI files and M2TS files of filenames from 00000 to 00006. The change from 603 is that the CLPI files and M2TS files of the filenames from 00004 to 00006 are added.

Accordingly, since the index file 600 and the movie object file 601 are not changed, and only the change of the play list file 702 and the file addition to the clip files 703 are performed. As a result, the change processing of the server is reduced and a network transfer amount is also reduced, advantageously reducing a time for downloading.

FIG. 8 shows the second example of the logical data structure of the recording medium after downloading and recording.

The same elements as FIG. 6 and FIG. 7 are not explained.

A movie object file 801 is changed from the movie object file 601 in that a command for playing the play list No. 1 is added.

The play list file No. 1 is shown by 804 and includes clips Nos. 4 to 6. Therefore, when the play list No. 1 is played in response to a command described in the movie object No. 1, three clips from clips Nos. 4 to 6 are played sequentially.

As described above, the index file 600 and play list file 602 are not changed, and only the change of movie object file 801, the addition of play list file 804, and the file addition of the clip 703 are performed. As a result, the change processing of the server is reduced and a network transfer amount is also reduced, advantageously reducing a time for downloading.

Since only the maximum file number and information about movie object files are notified to the server as the recording status at Step S307, the network transfer size may be further advantageously reduced. This is advantageous particularly when a size of the play list file is large.

FIG. 9 shows the third example of the logical data structure of the recording medium after downloading and recording.

The same elements as FIGS. 6, 7, and 8 are not explained.

An index file 900 is changed from the index file 600 in that a title No. 2 is added.

As described above, the play list file 602 is not changed, and only the change of the index file 900 and movie object file 901, the addition of the play list file 804, and the file addition to the clip 703 are performed. Accordingly, the change processing of the server is reduced and the network transfer amount is also reduced, advantageously reducing a time for downloading.

Since the structures of the title No. 1 and title No. 2 are independent of one another logically, the change of the structure of title No. 1 is unnecessary when adding the title No. 2, advantageously reducing a risk of affecting the playing of the title No. 1. Particularly, for example, when the title No. 1 which has been already recorded and the title No. 2 to be additionally recorded are provided from different movie companies respectively, the descriptions and types of the movie objects (one may be a BD-J object mentioned later) may be different. Accordingly, it is difficult to describe titles in a single movie object and therefore the third structure is preferable. Additionally, this structure in which a title having high independency is not susceptible to a title which has been already recorded is advantageous.

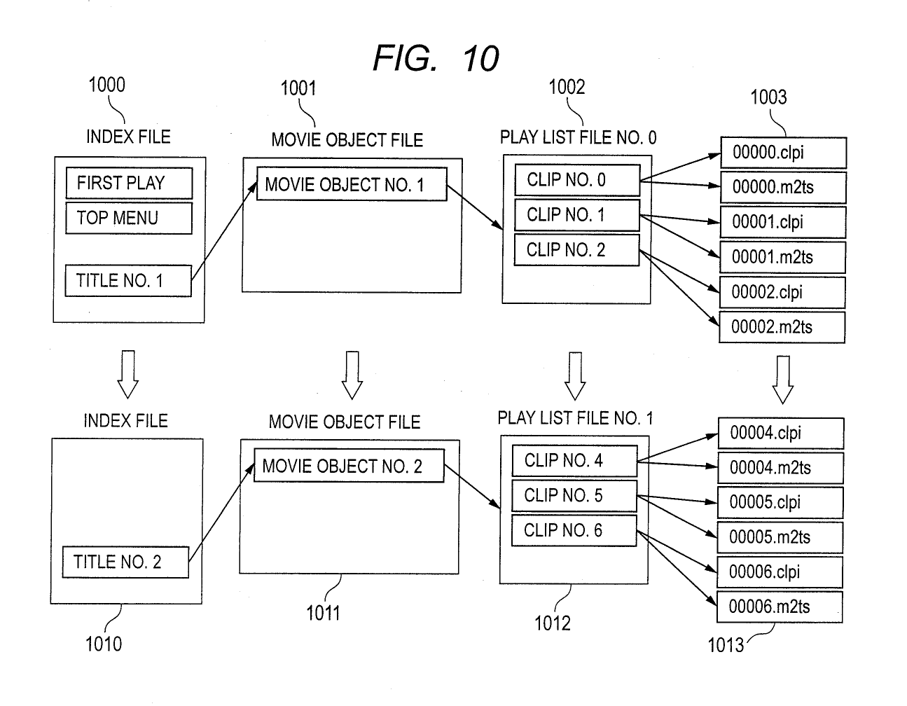

Next, FIG. 10 explains the management information file generation on the server and the filename changes executed in Step S309 of FIG. 3.

FIG. 10 explains an example of processing necessary for downloading and recording onto the recording medium before downloading shown in FIG. 7 to form the structure shown in FIG. 9 on the recording medium.

The upper half of FIG. 10 shows a state of a content to be downloaded before change, and in this state, the content can be sold and played as one volume of a BD package.

The server stores the content in this state, and on downloading, necessary changes are added to the content based on a recording status of a recording medium to which the content is downloaded. Then, the content is downloaded.

The lower half of FIG. 10 shows a state changed to form the structure shown in FIG. 9. These files are merged and added to the file group shown in FIG. 7 to achieve the state of FIG. 9.

An index file 1000 contains the title No. 1.

A movie object file 1001 includes the movie object No. 1.

The play list file No. 0 is shown by 1002 and includes clips Nos. 0, 1, and 2.

A clip group 1003 includes CLPI files of file numbers from 00000 to 00002 and M2TS files of file numbers from 00000 to 00002.

The file numbers (from 00000 to 00002) of the clip group of FIG. 10 overlaps with the file numbers (from 00000 to 00003) of the clip group of FIG. 7.

In this case, recording and downloading without changing the file names cause file name collisions and thus a problem such as an overwrite may occur.

Therefore, to avoid such duplication of filenames, it is effective that the notification of unused file numbers as shown in FIG. 3 is performed to change filenames on the server and responsively file numbers described in the play list files are changed.

Similarly, since the filenames of the play list files are also duplicate, the play list file number is changed from No. 0 to No. 1 and description of the movie object is changed to avoid the filename duplication.

The movie objects have two types, HDMV objects and BD-J objects, and the above explanation uses HDMV objects.

When using BD-J objects, a BD-J object exists in a movie object file instead of an HDMV object, and by executing a JAR file (not shown) stored in a JAVA (R) program, instead of executing a command, a necessary play list file is called to play a series of clips sequentially.

The downloading processing for BD-J objects is different from that for HDMV objects when changing an object file and adding a JAR file. The advantage according to the present invention is obtainable also when using BD-J objects.

For simple explanation, FIG. 2 shows only each file of a file number 00000. A long content such as a movie is often divided into multiple scenes. In this case, authoring is often performed in which each scene is assigned to one file. For example, even when N files are stored, N+1th or subsequent files are downloaded and added to obtain a similar advantage to the above.

Similarly, when multiple contents are downloaded at one time, the similar processing to the above is performed to obtain a similar advantage to the above.

According to the present invention, in the recorder for downloading and recording, additional recording of different contents onto a single recording medium can be achieved and the recording medium can be played by the existing players.

The present invention is not limited to the above-mentioned embodiments, and includes various modifications. For example, the above-mentioned embodiments have been explained in detail to clearly explain the present invention, but are not limited to a structure having all the explained elements. Additionally, part of a structure of one embodiment may be replaced by a structure of the other embodiment, and a structure of one embodiment may be added to a structure of the other embodiment. Additionally, in part of a structure of each embodiment, addition of the other structure, deletion, and replacement with the other structure are possible.

Additionally, part or all of each of above-mentioned structures, functions, processing sections, processing operations, etc. maybe realized using hardware, e.g., designed using an integrated circuit. Additionally, the above structures, functions, etc. may be realized by software by interpreting a program in which a processor achieves each function. Information such as programs, tables, and files for achieving each function may be stored in a recorder such as a memory, a hard disk, and a SSD (Solid State Drive) or in a recording medium such as an IC card, an SD card, and a DVD.

The control lines and information lines considered to be necessary are shown. All the control lines and information lines are not shown to achieve a product. Actually, generally all the structures may be connected to each other.

While we have shown and described several embodiments in accordance with our invention and it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A method for downloading and recording audiovisual data onto a recording medium,
the recording medium including a hierarchical folder structure having:
a STREAM folder storing an M2TS file in which audiovisual data is recorded,
a CLIPINF folder storing a CLIPI file in which management information is recorded, and
a PLAYLIST folder storing an MPLS file in which play information is recorded,
a filename of the M2TS file being a first file number,
a filename of the CLIPI file being a second file number,
the first file number and the second file number being a common file number in a one-to-one relationship,
a filename of the MPLS file being a third file number,
the folder structure having a movie object file describing a play order,
the MPLS file describing play information by use of the common file number, and
the movie object file describing a play order by use of the third file number,
the method comprising:
notifying unused numbers other than a number used for the third file number in file numbers usable as a filename of the MPLS file; and
selecting a forth file number from the unused numbers, and downloading and recording an MPLS file of a filename of the forth file number and a movie object file describing play information by use of the forth file number from a content delivery server.

2. A recorder for downloading and recording audiovisual data onto a recording medium,
the recording medium including a hierarchical folder structure having
a STREAM folder storing an M2TS file in which audiovisual data is recorded,
a CLIPINF folder storing a CLIPI file in which management information is recorded, and
a PLAYLIST folder storing an MPLS file in which play information is recorded,
a filename of the M2TS file being a first file number,
a filename of the CLIPI file being a second file number,
the first file number and the second file number being a common file number in one-to-one relationship,
a filename of the MPLS file being a third file number,
the folder structure having a movie object file describing a play order,
the MPLS file describing play information by use of the common file number,
the movie object file describing a play order by use of the third file number,
unused numbers other than a number used for the third file number in file numbers usable as a filename of the MPLS file being notified, and
a forth file number from the unused numbers being selected, and an MPLS file of a filename of the forth file number and the movie object file describing play information by use of the forth file number being downloaded and recorded from a content delivery server.

3. A recording medium for downloading and recording audiovisual data,
the recording medium including a hierarchic folder structure having
a STREAM folder storing an M2TS file in which audiovisual data is recorded,
a CLIPINF folder storing a CLIPI file in which management information is recorded, and
a PLAYLIST folder storing an MPLS file in which play information is recorded,
a filename of the M2TS file being a first file number,
a filename of the CLIPI file being a second file number,
the first file number and the second file number being a common file number in a one-to-one relationship,
a filename of the MPLS file being a third file number,
the folder structure having a movie object file describing a play order,
the MPLS file describing play information by use of the common file number,
the movie object file describing a play order by use of the third file number,
unused numbers other than a number used for the third file number in file numbers usable as a filename of the MPLS file being notified, and
a forth file number from the unused numbers being selected, and an MPLS file of a filename of the forth file number and the movie object file describing play information by use of the forth file number being downloaded and recorded from a content delivery server.
